(19) United States
(12) Patent Application Publication
(10) Pub. No.: US 2021/0291598 A1
(43) Pub. Date: Sep. 23, 2021

(54) PUNCTURE SENSOR ELEMENT AND TYRE WITH ADDITIONAL INTERNAL LAYERS AND A PUNCTURE DETECTION SYSTEM

(71) Applicant: BRIDGESTONE CORPORATION, Tokyo (JP)

(72) Inventors: Giampiero PAVONI, Roma (IT); Pasquale AGORETTI, Roma (IT); Giuseppe PEZZULLO, Roma (IT); Claudio D'ALFONSO, Roma (IT); Francesco MADAU, Roma (IT)

(73) Assignee: BRIDGESTONE CORPORATION, Tokyo (JP)

(21) Appl. No.: 16/320,823

(22) PCT Filed: Jul. 27, 2017
(86) PCT No.: PCT/EP2017/069047

§ 371 Date: Jan. 25, 2019

(30) Foreign Application Priority Data
Jul. 28, 2016 (IT) 102016000079463

(51) Int. Cl. B60C 19/00; B60C 19/12

(52) U.S. Cl. CPC B60C 19/00; B60C 2019/007; B60C 2019/004; B60C 19/122

(57) ABSTRACT

Sensor mesh suitable for use in a system for the detection of a puncture in a tyre, said sensor element having a wire structure arranged as a net comprising a first set of wires arranged according to a first direction (A) and a second set of wires arranged according to a second direction (B), in order to form meshes (M) of said net structure, wherein said wires of said first set of wires are of electrically non-conductive material and said wires of said second set of wires are of electrically conductive material, said wires of electrically conductive material being electrically connectable to each other in order to form a circuit configuration (c1, c2, c3, c4, c5), each of said meshes (M) having an inner area (A_{M}) of between 0.25 mm² and 100 mm².

### TECHNICAL FIELD OF THE INVENTION

The present invention relates to a tyre having additional inner layers, such as for example a sealant layer in order to prevent the leakage of air (or gas) in the case of a puncture or an insulating layer in relation to noise emissions during rolling of the tyre, and a system for the detection of punctures for subsequent warning of the driver.

### BACKGROUND

The use in tyres of a viscous sealant layer, generally arranged within the inner cavity of the tyre, has been known fora long time. In particular the sealant layer is generally arranged on the central area of the surface of the inner cavity located at the tread band. The purpose of the sealant layer is to surround and adhere to the object that has penetrated the tread and to fill the cavity left by the penetrating object following the possible expulsion thereof, thus, by virtue of instantaneous sealing, preventing any escape of air (or other gas) from the tyre.

Also known is the use in tyres of a layer of porous sound-absorbing material within the internal cavity of the tyre. The layer of porous sound-absorbing material is generally arranged on the central area of the surface of the inner cavity at the tread band. The purpose of the layer of porous sound-absorbing material is to reduce acoustic tyre emissions in the vehicle when the tyre is rolling.

In general, the additional layer (sealant and/or insulating) is adhered to the inner wall of the innerliner, i.e., the innermost layer of the tyre which is located within the cavity of the same.

The adhesion of the additional layer to the nnerliner is obtained by means of the use of adhesive materials, as for example in the case of the insulating layer wherein, generally, a strip of double-sided adhesive or bi-adhesive material is used, previously attached to one side of the grip of sound-absorbing material, or else, by virtue of the adhesive properties of the viscous insulating layer itself which adheres directly to the innerliner.

For the correct use of the tyre, it is essential that these additional layers adhere securely to the innerfiner throughout the entire life of the tyre and especially during the operation thereof.

On the other hand, this may instead represent a difficulty during the disposal phase of a worn tyre at the end-of-life thereof or during a possible repair of the same or during a possible either partial or complete replacement of the additional component. In fact, given the strong adhesion of the aforementioned additional layers to the innerliner, the removal thereof is complicated, where complete for the differentiated disposal of the various materials, and partial for a possible repair or replacement thereof, and can also affect tyre disposal operations, as well as the replacement and maintenance of the same layers or components.

Moreover, given the particularly adhesive and viscose nature of the sealant layer, it tends to adhere to the blades of machines that process tyres during disposal, also causing disadvantages to the same and in any case leading to the extraordinary maintenance and cleaning thereof.

Furthermore, also know from the prior art are several solutions for the detection of a puncture whilst driving, with the aim, indeed, of signaling the puncture event to the driver and then allowing the driver to accordingly adopt a driving style and behavior appropriate to the situation.

In some cases, such systems indude the application of at least a partially conductive sensor layer, to the innerliner, within the cavity of the tyre.

Given the importance, as mentioned above, of obtaining the perfect adhesion of a possible sealant layer to the wall of the innerliner, it is evident that the coexistence of a sealant layer and of sensor devices or layers can create problems in relation to the proper functioning of the sealant layer.

For this reason there is now felt the need for a solution that can combine the two technologies (sealant layer and puncture detection) in such a way that both solutions function as well as possible.

DE102008053506 discloses a tyre with a sealing material on the tire inner side wherein the tire inner side covered with the sealing material is provided with an electric warning system fastened at a tire module which releases an alarm during the breakdown of the tire.

US2007022805 discloses a tyre monitor for a vehicle including a sensor disposed in the tire, a power supply connecting ends of the sensor and applying a predetermined effort across the ends and causing a flow through the sensor, a meter disposed operabiy to the sensor to measure the flow and output a value substantially proportional to the flow, and a transmitter disposed operably to the meter to transmit the value to a vehicle information system, wherein the flow is reduced by a damage to the tyre.

EP1356957 discloses a tyre comprising numerous inner sensor units for determining operating parameters of the tyre; the sensors can select measured values, and are attached to a fibre network which is vulcanized into the tire. The network fibres are electrically conducting and can be connected to a central unit.

### SUMMARY OF THE INVENTION

The technical problem addressed and solved by the present invention is therefore to provide a sensing element for a system for the detection of a puncture in a tyre, especially of the type comprising an inner sealant and/or insulating layer. This is obtained by means of a sensor element as defined by claim 1.

The object of the present invention is also a tyre that envisages the presence of an additional layer (sealant and/or insulating), together with a system for the detection of a puncture, as defined in claim no. 16.

Further characteristics of the present invention are defined in the corresponding dependent claims.

The present invention, overcoming the problems of the prior art, involves numerous and obvious advantages.

In particular, the special construction of the sensor layer according to the present inventions is such that it does not constitute an obstacle to the adhesion of a possible sealant layer to the innerliner.

Furthermore, the sensor layer is such as to facilitate the detachment of the sealant layer when disposing of the tyre without incurring the aforementioned disadvantages and difficulties.

### BRIEF DESCRIPTION OF THE FIGURES

The advantages, characteristics and usage of the present invention will become clear from the following detailed description of preferred embodiments thereof given purely by way of non-limiting examples.

Reference will be made to the figures of the accompanying drawings, wherein:

FIGS. 1 and 1A are respectively a schematic plan view of a sensor element according to the present invention and a detail thereof;

FIGS. 2A to 2E schematically show possible circuit configurations of the wires made from a conductive material of a sensor element according to the present invention;

FIG. 3 is a cross-section view of a tyre according to the present invention;

FIG. 4 is a cut-away view of a tyre, showing the layout of the sensor element and of the sealant and/or insulating layer of a tyre;

FIG. 4A shows a detail from FIG. 4;

FIG. 5 is a schematic equatorial section view of a tyre according to the present invention during the phase of removing the sealant and/or insulating layer.

### DETAILED DESCRIPTION OF EMBODIMENTS OF THE INVENTION

Some embodiments of the present invention will be described below, making reference to the above figures.

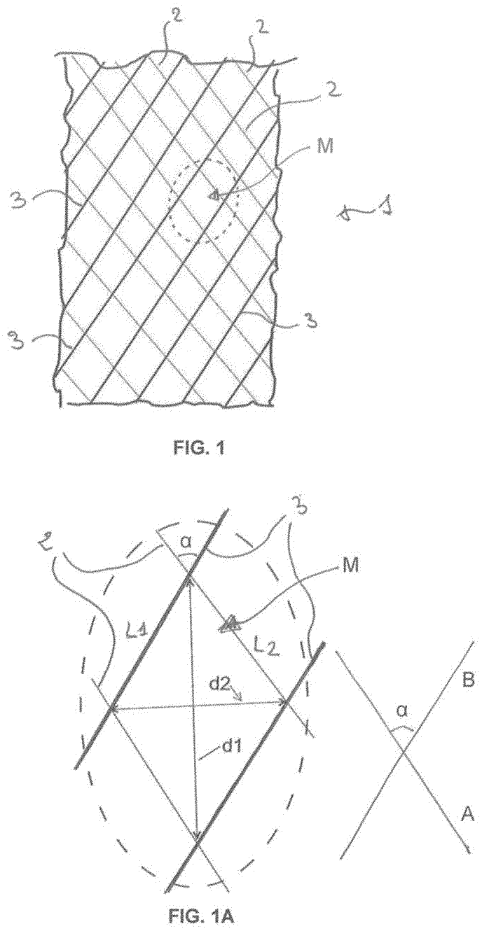

Referring, firstly, to FIG. 1, this is a schematic plan view of a portion of a sensor element 1 according to the present invention, while FIG. 1A shows a particularity thereof in more detail.

In general, the sensor element 1 is intended to be used within a system for the detection of a puncture in a tyre. More specifically, it is intended to be positioned within the cavity of a tyre, between the inneriiner and the sealant and/or insulating layer, at the tread belt. Accordingly , the sensor element 1 will therefore be designed with dimensions and shapes suitable for such positioning.

Overall the sensor element 1 presents itself as a structure of wires arranged in the form a net. The wires can be interwoven or fastened to each other in any other way.

More specifically, said structure comprises a first set of wires 2 arranged in a first direction A and a second set of wires 3 arranged in a second direction B in order to form corresponding meshes M of the net structure.

Even though this does not necessarily constitute a strict constraint, according to some embodiments the wires of each set of wires are arranged parallel to each other and evenly spaced therebetween, with the two sets of wires arranged in such a way as to cross over one another, so to form a net from meshes that are all the same and preferably of a substantially quadrilateral shape.

Each mesh M will therefore have respective sides L1, L2, each with a length of between 0.5 mm and 10 mm.

According to a particular embodiment, the meshes M have sides of the same length of about 3 mm.

Preferably, the first direction A and the second direction B form between them an angle α of between 30° and 150°.

It is, however, to be understood that the arrangement of the wires may also give rise to configurations of meshes of different shapes, although still forming a net structure.

The wires of the first set of wires 2 are of an electrically non-conductive material, while the wires of the second set of wires 3 are of an electrically conductive material and effectively constitute the component that enables the detection of a puncture. For such a purpose, the wires 3 of an electrically conductive material can be connected together in order to form a pre-established type of circuit configuration, that then responds to laws such as Ohm's law. For example, the circuit configuration can be of the following types: series, parallel, comb, mixed.

The arrangement of the wires is therefore such as to form a mesh M, having an internal area A_{M} preferably of between 0.25 mm² and 100 mm².

Depending upon the specific application of the sealant and/or insulating material used in conjunction with the sensor element 1, the same can be implemented in such a way that the area of the single mesh has the best surface in terms of performance and detection.

As will be explained below, the net structure is fundamental to allow for the passage of the viscous material of the sealant layer (or insulating layer) through the sensor element 1, and to allow that the sealant layer for insulating iayer) perfectly adheres to the innertiner of the tyre.

In fact, particularly in the case of the presence of a sealant layer, the functionality of this layer is essentially determined by the perfect adhesion of the same to the innerliner. Poor adhesion may impair the ability of the sealant material to adhere to the perforating body that penetrates the tyre, therefore impairing the effectiveness of the sealing function.

On the other hand, as will be clarified below, the sensor element 1 also performs the function of facilitating the removal of the sealant layer during tyre disposal phases.

Therefore, according to a possible embodiment, the area A_{M} of the single mesh M is between 0.5 mm² and 80 mm², preferably between 1 mm² and 50 mm², more preferably the area of the single mesh is approximately 20 mm².

Therefore, a net layer with meshes of such dimensions, interposed between the innertiner and the sealant material layer, on the one hand ensures the flow of the sealant material into a possible hole left by the perforating object; on the other hand it offers sufficient resistance in the act of being removed to be able to detach the sealant layer without it passing through the meshes and instead remaining attached to the innertiner.

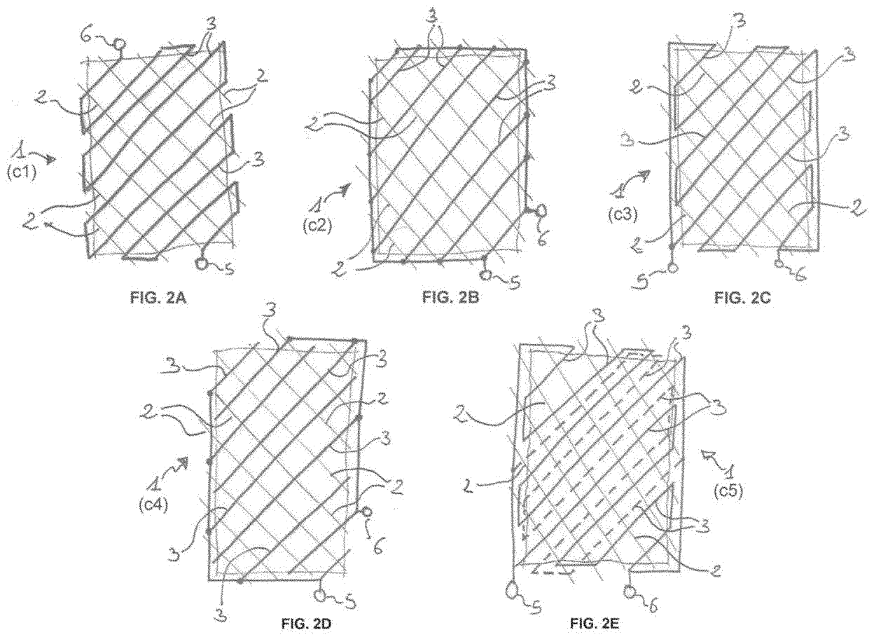

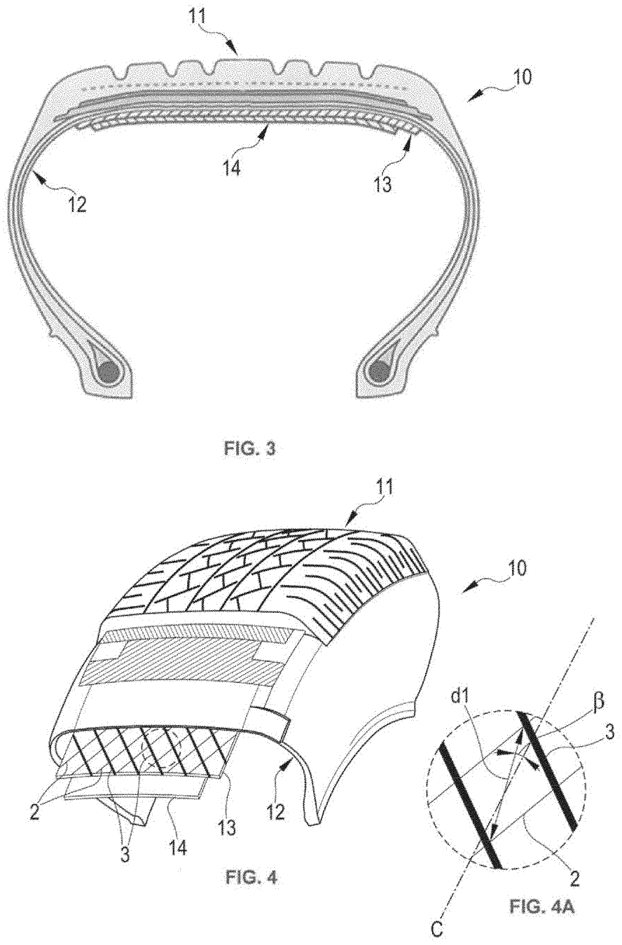

The subsequent FIGS. 2A to 2E show, in a simplified and schematic manner, some possible circuit configurations c1, c2, c3, c4, c5 of the conductive wires 2.

In particular, FIG. 2A represents an embodiment of the sensor element wherein the conductive wires 3 are all electrically connected in series so as to form a single conductor having at the ends corresponding contact terminals 5, 6 for connection to an electronic measurement and/or detection device.

FIG. 2B represents an embodiment of the sensor element wherein the conductive wires 3 are all electrically connected in parallel by means of two main conductors that have contact terminals 5, 6.

FIG. 2C represents an embodiment of the sensor element wherein the 5 conductive wires 3 are grouped, the wires of each group are connected in series and the different groups are interconnected in parallel.

FIG. 2D represents an embodiment of the sensor element wherein the conductive wires 3 are arranged In a comb configuration, i.e., wherein the wires 3 of a conductive material are alternately connected to two main to conductors which have the contact terminals 5, 6.

FIG. 2E represents an embodiment of the sensor element wherein the conductive wires 3 are arranged in a mixed configuration, i.e., that provides groups of wires in series, connected to each other in parallel. However, such a configuration provides the overlapping of one or more groups of wires in such a way as to further reduce the area of the meshes and therefore increase the sensitivity of the sensor element, increasing the probability of the wires 3 breaking in the case of a puncture. According to this configuration, the wires 3 are preferably coated with an insulating layer in such a way as to prevent them from coming into contact with each other at points of overlap.

It is to be understood that other configurations can be provided

Each of these possible configurations corresponds to different sensor behavior, as will be described more clearly, and therefore each configuration can be chosen during the tyre design phase as a function of the required behavior thereof.

In each case, a parameter to be considered during the construction of the sensor element is the resistivity p of the conductive wires 3.

In fact, as will be apparent from the following, the detection of a puncture is obtained by means of measuring variations in the value of resistance of the sensor elements.

Preferably, the wires 3 of a conduciive material are made from a material with a resistivity ρ of between 1*10⁻⁸ Ohm*meter and 100 Ohm*meter.

This material can, for example, be selected from: copper, aluminum, iron, carbon. It could, however, also be a non-metallic material (for example, a conductive polymer or a polymer loaded with conductive particles).

In addition, aiso the cross-sectional area of the conductive wires 3 influences the behavior of the sensor element, therefore, assuming the use of circular section wires, it is preferable to use conductive wires 3 with a diameter of between 0.01 mm and 1 mm. corresponding to a cross-section surface area S of between 3.14*10⁻⁴ mm² and 3.14 mm².

It is evident that if they were to have a different cross-sectional shape, the wires would have to be dimensioned in such a way as to have a cross-section surface area equivalent to that of S indicated above.

More preferably, the wires of said set of wires 3 have a diameter of between 0.01 mm and 0.5 mm.

Generally, the perforation of the sensor element by a typically metallic perforating element (e.g., nail) causes the breakage of one or more wires of the net structure and in particular one or more of the wires 3 made from a conductive material.

It follows that by interrupting all or part of the electrical circuit of which the sensor element forms a part, it is possible to measure, at the contact terminals 5, 6, a variation compared to the nominal value of the resistance of the intact sensor element.

Evidently, it is also possible that the perforating element will not cause the breakage of any conductive wire 3. However, even in such an unlikely event, given the dimensions of the mesh and therefore the distance between the conductive wires, it will almost certainly be the case that the perforating element places two or more conductive wires in contact to each other, thereby altering the circuit configuration and therefore in any case leading to a change in the resistance value.

A comb configuration of the kind described above could better match with such a function and, in this case, it would be preferable to adopt conductive wires with a diameter near to the maximum indicated value.

In the other cases, corresponding to the serial, parallel or mixed configurations, mostly based on ihe breakage of one or more conductive wires, it is preferable to use conductive wires 3 with a diameter of between 0.01 mm and 0.5 mm.

As indicated from the beginning, the net structure is formed from two sets of wires, of which the first set of wires 2 comprises wires made from an electrically non-conductive material. Such wires, interwoven, woven or in some other way connected to the conductive wires 3, indeed implement the net structure and essentially constitute the structural component thereof

Without this constituting a limitation, the non-conductive material of the wires in the first set of wires is selected from at least: polyesters, polyamides, natural fibers, carbon fibers, glass fibers or the combinations thereof. In particular PE, PP, PET, nylon, aramid, rayon.

Assuming, also in this case, the use of non-conductive wires 2 having a circular cross-section, the diameter thereof is preferably between 0.01 mm and 1 mm, corresponding to a cross-section area S of between 3.14*10⁻⁴ mm² and 3.14 mm².

It is evident that if they were to have a different cross-sectional shape, the wires would have to be dimensioned in such a way as to have a cross-section surface area equivalent to that of S indicated above.

Preferably, the ratio between the number of wires made from a conductive material and the total number of wires made from a non-conductive material can be between 1 and 9.

As stated above, the sensor element 1 of the present invention is intended to form part of a system for the detection of a tyre puncture.

In particular, with reference to the figures from 3 to 5, a further object of the present invention is a tyre 10 comprising a sealant and/or insulating layer 14, preferably viscous, arranged between the innerliner 12 and the inner cavity 15 of the tyre 10, at the tread belt 11, and that comprises a sensor layer 13 in turn comprising one or more sensor elements 1 according to the present invention. The sensor layer 13 is interposed between the innerliner 12 and the sealant and/or insulating layer 14.

More specifically, FIG. 4 shows, by way of a non-limiting example, a possible arrangement of the sensor layer 13 and, more specifically, the positioning of a sensor element 1 according to the invention.

In the same way, as shown more clearly in FIG. 4A, it is preferable that each sensor element 1 be positioned with respect to the tyre such that a diagonal d1 of the mesh M is oriented in such a way as to form an angle β with the direction C of the circumference of the tyre. This angle β preferably assumes a value of between 0° e 90°.

In particular, it is preferable that each sensor element 1 be positioned, in relation to the tyre, in such a way that a diagonal d1 of the mesh M is oriented along the circumferential axis of rotation of the tyre (β=0°) while the other diagonal d2 is oriented in an axial manner along the tyre.

In the case wherein the shape of the net is such that the two diagonals have different lengths, it is preferable that d1 has the longer diagonal. In this way it is easier to remove the sealant layer in the direction of the circumference of the tyre.

From a construction point of view, the sensor layer 13 may comprise a plurality of sensor elements 1, electrically connected to each other in series and/or in parallel, but nonetheless implementing a uniform net structure, by virtue of cooperation with the wires made of a non-conductive material.

The sensor layer 13, given the aforementioned characteristics of the conductive wires 3, will, however, be configured in such a way as to exhibit an overall electrical resistance that may vary from 0.001 Ohm, for example, in the case of a plurality (e.g., 20) of sensing elements in a series configuration interconnected in parallel, and 100 MOhm, for example, in the case of an entirely series or parallel configuration.

By way of example, in the simplest case wherein the sensing elements within a tyre are of the series configuration type and in turn connected therebetween in series, the entire and single conductive wire of the sensor layer may have a length of about 600 m (assuming a tyre with a diameter of 1000 mm, a net pitch of 1 mm and a length of 3000 mm for each single wire).

It results that the overall resistance Rs of the intact sensor layer, assuming a resistivity ρ of the material equal to 1*10⁻⁸ Ohm*meter, is equal to 120 Ohm. Of course, in the case of damage caused by a perforating element, the resistance Rs will assume an infinite value.

Furthermore, by way of a non-limiting example, and in the case wherein the sensing elements within a tyre are of the series configuration type and in turn connected to each other, up to a certain number Np, in parallel, and under the same dimensional conditions and with the same materials as in the previous example, the sensor layer 13, overall, would have a resistance Rsp given by the ratio between the previous series resistance Rs and Np. For example, if the number Np of parallel connections were to be 400, the total resistance value Rp would be 588 Ohm.

In this case, in the event wherein the puncture results in the breakage of a single conductive wire, the total resistance wouid change to about 590 Ohms.

These examples only serve to show that anyway, the perforation by a perforating element that leads to the breakage of at least one of the conductive wires 3, causes a variation in the value of the overall electrical resistance of the sensor layer 13.

In general, for configurations that function based upon the breakage of one or more conductive wires, the perforation is reflected in an increase in the overall resistance of the sensor layer. In the case of a ‘completely series’ configuration the increase is infinite, in the case of a ‘mixed’ configuration, the post-breakage resistance will be greater than the nominal value of the intact sensor layer, but still generally be less than 1 GOhm.

Otherwise, in the case of configurations that function based upon a short circuit between a number of conductive wires (for example the comb configuration), the perforation is reflected in a decrease in the overall resistance of the sensor layer.

In the same way, a tyre 10 according to the present invention, may also comprise an electronic device 20, which is electrically connected to the sensor layer 13 and that is configured to measure the electrical resistance value of an electric circuit resulting from the connection of the sensor elements 1 in the sensor layer 13.

Such a device 20 is preferably equipped with wireless data transmission means for transmitting data, in this case measured electrical resistance values, to corresponding receiving devices on board the vehicle to which the tyre 10 is fitted, which devices can be programmed to determine changes in the resistance measurements and, by means of comparing thresholds defined according to the type of tyre fitted (this can be a datum to be set based upon predetermined settings), determine a puncture condition and generate a puncture event signal in order to provide the driver with a warning.

Alternatively, the same device 20 can be further configured to detect changes in resistance values and, by means of a comparison with predefined thresholds (in this case they can be predetermined during manufacture of the tyre), determine a puncture condition and generate a puncture event signal to be transmitted to the apparatuses on board in order to provide the driver with a warning.

The use of electronic devices for the detection of various parameters on-board a tyre (pressure, temperature, etc.) and for the wireless transmission of such data to on-board apparatuses is generally considered possible for an expert in the field and it is therefore not considered necessary to provide a detailed description thereof.

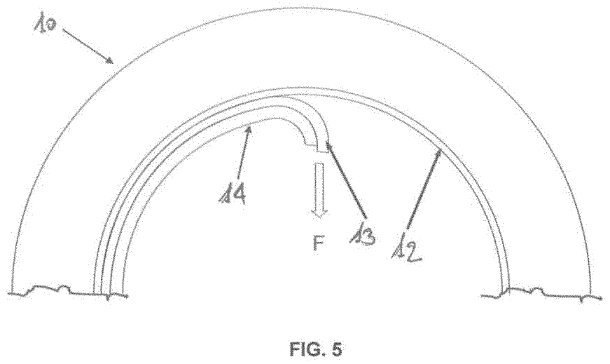

The following FIG. 5 shows how, at the end-of-life of the tyre, the sensor layer 13 can advantageously be used to completely remove, and without any disadvantages, the sealant and/or isolating iayer from the inner wall of the innerliner.

In fact, the structural component of the sensor layer 13 is sufficiently robust to ensure that the viscous sealant material, which, otherwise, it would not have been possible to remove easily, is pulled away together with the same sensor layer.

The present invention has heretofore been described with reference to the preferred embodiments thereof. It is intended that each of the technical solutions implemented in the preferred embodiments described herein by way of non-limiting examples can advantageously be combined in different ways therebetween, in order to give form to other embodiments belonging to the same inventive nucleus and that all fall within the scope of protection afforded by the claims recited hereinafter.

1. Sensor element (1) suitable for use in a system for the detection of a puncture in a tyre (10), said sensor element (1) having a wire structure (2, 3) arranged as a net comprising a first set of wires (2) arranged according to a first direction (A) and a second set of wires (3) arranged according to a second direction (B), in order to form meshes (M) of said net structure,
wherein said wires of said first set of wires (2) are of electrically non-conductive material and said wires of said second set of wires (3) are of electrically conductive material, said wires (3) of electrically conductive material being electrically connectable to each other in order to form a circuit configuration (cl, c2, c3, c4, c5),
each of said meshes (M) having an inner area (A_{M}) of between 0.25 mm² and 100 mm², such as to allow for the passage of a viscous material through said sensor element (1), the sensor element (1) being suitable for being positioned on the innerliner of the tyre (10), within the inner cavity of the same.

2. Sensor element (1) according to claim 1, wherein each of said meshes (M) has a substantially quadrangular shape.

3. Sensor element (1) according to claim 1, wherein said wires (3) of conductive material are made from a material having a resistivity (ρ) of between 1*10⁻⁸ Ohm*meter and 100 Ohm*meter.

4. Sensor element (1) according to claim 1, wherein said circuit configuration (c1, c2, c3, c4, c5) can be of the types: series, parallel, mixed, comb.

5. Sensor element (1) according to claim 1, wherein said first and second directions (A, B) form an angle (α) between them of between 30° and 150°.

6. Sensor element (1) according to claim 1, wherein said wires of said first set of wires (2) have a diameter of between 0.01 mm and 1 mm.

7. Sensor element (1) according to claim 1 wherein said wires of said second set of wires (3) have a diameter of between 0.01 mm and 1 mm.

8. Sensor element (1) according to claim 7, wherein said wires of said second set of wires (3) have a diameter of between 0.01 mm and 0.5 mm.

9. Sensor element (1) according to claim 1, wherein each of said meshes (M) has an inner area (A_{M}) of between 0.5 mm² and 80 mm².

10. Sensor element (1) according to claim 1, wherein each of said meshes (M) has an inner area (A_{M}) of between 1 mm² and 50 mm².

11. Sensor element (1) according to claim 1, wherein each of said meshes (M) has an inner area (A_{M}) of about 20 mm².

12. Sensor element (1) according to claim 1, wherein each of said meshes (M) has respective sides (L1, L2) having each a length of between 0.5 mm and 10 mm.

13. Sensor element (1) according to claim 2, wherein said length of the sides (L1, L2) of each mesh is of about 3 mm.

14. Sensor element (1) according to claim 1, wherein the conductive material of the wires of said second set of wires (3) is selected from at least: copper, aluminum, iron, carbon, conductive polymer or loaded with conductive particles or a material coated with conductive paint.

15. Sensor element (1) according to claim 1, wherein the non-conductive material of the wires of said first set of wires (2) is selected from at least: polyesters, polyamides, natural fibers, carbon fibers, glass fibers or combinations thereof, in particular PE, PP, PET, nylon, aramid, rayon.

16. Tyre (10) comprising a tread belt (11) and an additional layer (14) of viscous material arranged between the innerliner (12) and the inner cavity (15) of the tyre (10) at the tread band (11), and a sensor layer (13) comprising one or more sensor elements (1) according to claim 1 interposed between the innerliner (12) and said additional layer (14).

17. Tyre (10) according to claim 16, wherein said additional layer (14) is a sealant and/or insulating layer.

18. Tyre (10) according to claim 16, wherein said sensor layer (13) comprises a plurality of sensor elements (1) electrically connected to each other in series and/or in parallel.

19. Tyre (10) according to claim 16, wherein said sensor elements (1) are positioned, in relation to the tyre, such that a diagonal (d1) of the meshes (M) is oriented in such a way as to form an angle (β) with the direction (C) of the circumference of the tyre, said angle (β) assuming a value of between 0° and 90°.

20. Tyre (10) according to claim 19, wherein said angle (β) is equal to 0°.

21. Tyre (10) according to claim 16, also comprising an electronic device (20) connected to said sensor layer (13) and configured in order to measure the value of electrical resistance of the electric circuit resulting from the connection of said sensor elements (1).

22. Tyre (10) according to claim 16, wherein said electronic device (20) comprises wireless data transmission means, in order to transmit data to corresponding receiving apparatuses on board the vehicle to which the tyre (10) is fitted.

23. Tyre (10) according to claim 21, wherein said electronic device (20) is further configured in order to detect variations in such resistance value that are attributable to a puncture and to consequently generate a puncture event signal to be transmitted to said receiving apparatuses in order to provide the driver of the vehicle with a warning.
